(19) United States
(12) Patent Application Publication
(10) Pub. No.: US 2014/0076120 A1
(43) Pub. Date: Mar. 20, 2014

(54) HANDLED PLECTRUM AND STRAP-RETAINER ASSEMBLY

(71) Applicant: James Theodore Hollin, JR., Tyrone, GA (US)

(72) Inventor: James Theodore Hollin, JR., Tyrone, GA (US)

(21) Appl. No.: 14/027,223

(22) Filed: Sep. 15, 2013

Related U.S. Application Data
(60) Provisional application No. 61/701,132, filed on Sep. 14, 2012.

(51) Int. Cl. G10D 3/16

(52) U.S. Cl. CPC G10D 3/163
USPC 84/322

(57) ABSTRACT

For musicians playing an electric or acoustic guitar, there is disclosed a re-designed plectrum having an orthogonally-protruding handle and a snubber extending from the handle. The handle and snubber allow the plectrum to be inserted into the channel of a flexible, primarily longitudinal strap-retainer. The plectrum and strap-retainer, thus connected, form a one-piece handled plectrum assembly, with the strap-retainer being fastened about one, two, or three fingers of the user. The disclosed plectrum assembly provides an improvement in the gripping surface available to the user, in addition to providing more comfort and more reliable thumb and forefinger gripping orientation. The assembly also permits a rapid release of the plectrum for finger-plucking or strumming style of play.

### CROSS-REFERENCES TO RELATED APPLICATIONS

This application claims the benefit of priority from U.S. Provisional Application No. 61/701,621 filed on Sep. 15, 2012 and said provisional application is incorporated fully herein as though appearing as part of this application.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

(1) Field of the Invention

The inventive concept presented herein generally is concerned with devices and methods for playing stringed musical instruments, especially guitars. Historically, stringed instruments such as guitars, bass guitars, banjos, mandolins and the like are played either with the fingers, or more frequently, with the assistance of a plectrum. Plectrums come in a variety of sizes, weights, densities, materials, and textures. They are usually 0.5 mm to 1.0 mm thick, but can be much thicker. Plectrums are generally constructed in the approximate shape of an isosceles triangle, with rounded base angles and a relatively elliptical apex, or “picking point.” The musician normally orients the plectrum so as to make the apex point the part of the plectrum which strikes the strings of the instrument.

It is not uncommon for a musician to lose the most effective position of his or her grip on the plectrum while playing, or to drop the plectrum entirely when playing rapid or intense passages consisting of multitudes of musical notes. If the grip on the plectrum is accidentally misaligned, the musician may not be able to timely strike the string or strings which for which he or she is aiming, and as an added consequence, the timbre of the string, or the quality of its induced resonance is lessened by such a mis-strike.

(2) Description of the Related Art

Musicians and instrument makers have been, for over one hundred years, making improvements and modifications in the basic simple plectrum, to make the device more versatile or convenient to use. A very early invention in this vein was designed in 1896, and involved a holder device for mandolin picks; ref. U.S. Pat. No. 557,293. The holder was flexible enough such that, by varying pressure on the device with the thumb and forefinger, a musician was able to strike the mandolin strings very soft with low volume or with force for louder, more emphatic tones. The holder minimized the risk of dropping the pick or losing grip.

In 1916, U.S. Pat. No. 1,184,561 presented a design for a mandolin pick holder which resembled a miniature horseshoe. The device was made with a recessed chamber, sized so as to accommodate the insertion of the pick. The preferred embodiment of the device was made of rubber, which gave enhanced gripping qualities to the musician, as the gripping pressure of the fingers engaged the friction of the rubber. The pressure of the fingers also provided a firm retention force for maintaining the pick inside the horseshoe-shaped receptacle.

U.S. Pat. No. 1,263,740 features a pick for stringed instruments which is constructed with a small hole or aperture at the gripping end of the pick. A thin wire is inserted through the hole and then looped on both sides of the pick. The double loops provide resting places, or anchors, for the two most conveniently located fingers involved in gripping the pick for playing.

U.S. Pat. No. 2,776,592 describes a guitar pick attachment designed with a ring-like mechanism to fit over the forefinger. This helps prevent accidental dropping of the pick. The ring-like mechanism is connected to the pick by a “tongue” that is an integral part of the pick. The pick may be swiveled around its position on the ring-like mechanism to a non-playing position, which allows freedom of the fingers to pluck the instrument.

U.S. Pat. No. 3,699,838 consists of a guitar pick manufactured with an integral, continuous circular band extending from both sides of the pick. The band is designed with sufficient tension so as to securely hold a thumb or finger as that digit is inserted within the circular band in preparation for gripping the pick.

U.S. patent application Ser. No. 12/660,984 discloses a plectrum with an extended tab wherein an aperture within the tab accepts a tether which may be looped around the hand or selected fingers of the musician.

A relatively intricate pick design is disclosed in U.S. Pat. No. 4,270,433, which claims a plectrum ring. The ring element is designed to be worn about the middle finger of the musician's playing hand, with the plectrum being snapped into place by means of a stud and boss assembly on the surface of the ring element. The plectrum may have one or more boreholes drilled into it to allow a selection of multiple positions and angles for the plectrum to be attached to the ring element. Other variations of this basic mechanism are further disclosed.

U.S. Pat. No. 4,497,237 consists of a guitar pick with two curved metallic bands attached to the pick. The pick itself has two small pads, one glued to each side of the gripping half of the pick. There are grooves within the pads to allow the insertion of the two bands. The bands are relatively stiff but deformable to allow insertion of the musician's fingers and also to allow the pick to be swiveled out of playing range when the pick is not in use.

U.S. Pat. No. 5,837,913 features a plectrum which is attached to a flexible tongue device, which in turn is connected to a bendable, circular hand engaging member. The hand engaging member is designed to be variably fitted onto the base of the musician's middle finger. Thereafter, the flexible tongue stretches to allow the pick to be grasped by the musician's thumb and forefinger for playing the instrument.

An abandoned British patent application (publication #GB2347550) discloses a variety of plectrum devices, including one with a handle to be grasped in the user's fist. At least one variety of the handle is manufactured with a tongue-like device which is integral to the handle and extends outward an appropriate distance so as to allow the attachment of a pick to the tongue.

Another development with respect to playing stringed instruments is a device referred to as the F-1™ “Ergonomic Guitar Pick.” This invention is described in U.S. Pat. No. 6,054,643 and is designed to be used as either a pick or a pick holder. It resembles an inverted clamshell, and features a pick of engineered material with a curved finger grip. One side of the device is a finger cradle, or saddle, to accommodate either the thumb or the index finger of the musician. The opposite side of the device is a flat planar area for ease of gripping with pressure exerted by the other fingers.

### BRIEF SUMMARY OF THE INVENTION

The inventive concept herein discloses a re-designed plectrum 1 having a protruding handle 3 oriented at an angle between approximately seventy to ninety degrees to the axis 6 of the plectrum body 5 and a “snubber” 4 extending from the handle 3. The handle 3 and snubber 4 enable the plectrum 1 to be inserted into a channel 10 of a flexible, primarily longitudinal strap-retainer 20. The plectrum 1 and strap-retainer 20, thus assembled, form a one-piece handled plectrum assembly 21 with a resulting inner loop. The handled plectrum assembly 21 may then be fastened to itself, forming a loop to enclose one to three fingers of the playing hand of the user/musician.

The disclosed handled plectrum assembly 21 features an improvement in the gripping surface available to the musician or player of a stringed musical instrument. There is also provided for the player more comfort, more reliable thumb and forefinger gripping pressure, and a greater consciousness of ergonomically correct muscular movements when playing a stringed musical instrument, particularly an electric guitar. The handled plectrum assembly 21 allows a musician or player to more effectively hold the plectrum 1 and to apply more accurate placement when the plectrum 1 strikes the strings of the instrument.

For illustrative purposes only, this disclosure presents peg-and-hole and also hook-and-felt type fastening mechanisms. Another means of connecting the device in the fastening zone 15 of the plectrum assembly is a hook-and-felt mechanism, with the hook component being the male fastener and the felt component being the female fastener. However, a variety of fastening mechanisms may be used in the fastening zone 15 of the device, including, but not limited to, press-fit elastomeric grooves, magnetic materials, peg and through-hole fasteners, and tongue-and-groove fittings. For ease of description and convenience sake only, the references to playing function of the handled plectrum assembly shall be with respect to a user's (musician/guitarist) playing of a guitar.

### DESCRIPTION OF THE VIEWS OF THE DRAWINGS

The objects, features, and advantages of the concepts presented in this application are more readily understood when referring to the accompanying drawings. The drawings, totaling ten figures and sub-figures, show the basic functioning of the plectrum assembly, combined with two of the preferred embodiments of the device. In the several figures, like reference numbers are used in each figure to correspond to the same component as may be depicted in other figures.

FIG. 1 depicts the fastened handled plectrum assembly utilizing a through-holes and pegs mechanism in the fastening zone of the device.

FIG. 2 depicts the arrangement of through-holes and pegs as the male and female fasteners, respectively.

FIG. 2(a) is an end view of the receptor, showing the shape of the channel.

FIG. 3 shows a side-view of a strap-retainer which utilizes the through-holes and pegs fastening mechanism.

FIG. 4 presents a strap-retainer with a hook-and-felt fastening mechanism.

FIG. 4(a) is an end view of the receptor, showing the shape of the channel.

FIG. 5 depicts a strap-retainer with a hook-and-felt fastening mechanism.

FIG. 6 depicts a view of the planar surface of the plectrum, further showing the axis passing through the apex of the plectrum.

FIG. 6 (a) is an edge view of the plectrum, as seen looking at the outer edge, or brace, of the snubber component.

FIG. 7 depicts a guitar player's right hand after fastening the strap-retainer about his/her bottom three fingers.

Nomenclature of Components

```
  1. Plectrum
  2. Planar dimension
  3. Handle
  4. Snubber
  5. Body
  6. Axis
  7. Apex
  8. Brace
  9. Receptor
10. Channel
11-12. n/a
13. Flap
14. Flap angle
15. Fastening zone
16. Felt component
17. Hook component
18-19. n/a
20. Strap-retainer
21. Handled plectrum assembly
22. Top edge
23. Lower edge
24. Back end
25. Front end
26. Inner surface
27. Outer surface
28. Thumb-tip
29. Index finger
30. Through-hole segment
31. Peg segment
```

### DETAILED DESCRIPTION

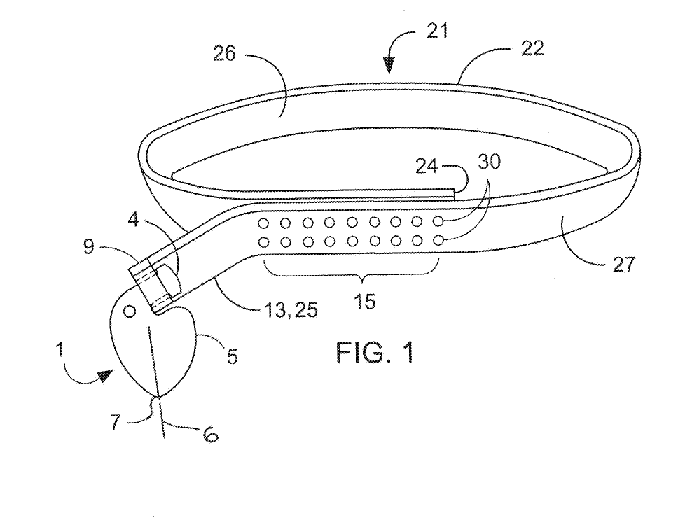

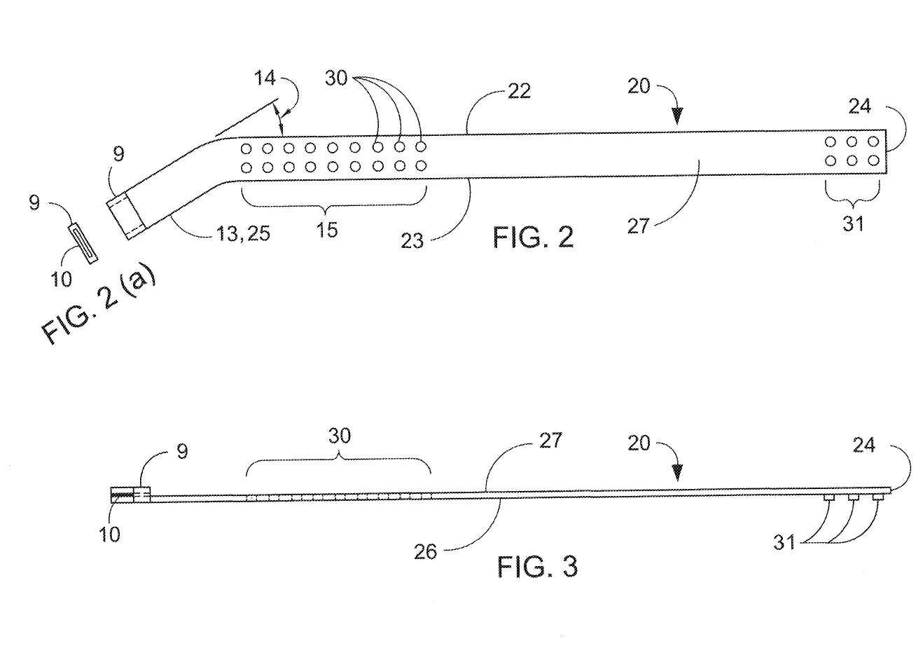

For an overall view of the inventive concept, analysis shall begin with FIG. 1. in FIG. 1 there is shown a fastened handled plectrum assembly 21 which subsequently forms a loop defined by the inner surface 26 of the handled plectrum assembly 21. For the inventive concept to function as intended, the plectrum 1 is inserted into what is termed a “receptor” 9 of a “flap” 13 component. The flap 13 is integrally connected to a strap-retainer 20 at a “flap angle” 14 of approximately thirty degrees. The angular connection enhances a guitarist's orientation of the apex 7 of the plectrum 1 striking the strings of the guitar. The flap-angle 14 may be manufactured at a greater or lesser angle, depending on the comfort level of a particular player's plectrum grip style. In viewing FIG. 2, the flap-angle 14 is more clearly shown, which preferably is constructed at an angle, relative to the top edge 22 of the strap-retainer 20.

The strap-retainer 20 is an essentially longitudinal strap, comprising a top edge 22, a lower edge 23, a back end 24, a front end 25, an outer surface 26, an inner surface, 27, and a fastening zone 15. In the preferred embodiment, the strap-retainer 20 is constructed from an elastomeric material; however any material that is relatively bendable or flexible may be used.

In the embodiment shown in FIG. 1, the back end 24 of the strap-retainer 20 is shown detachably connected to the fastening zone 15 proximate the front end 25 of the strap-retainer 20. The back end 24 of the strap-retainer 20 provides the location for affixing any variety of male fastener segments. The fastening zone 15 provides the location for any of a variety of female fastener segments corresponding to the particular male fastener segment used. In FIG. 1, there is shown an arrangement of through-holes 30 forming the female fastening segment, while the male fastener segment (out of view) comprises a matching arrangement of raised pegs 31.

In referring to FIG. 2 and FIG. 3 there is also shown a peg-and-hole fastening mechanism wherein the male fastening segment (pegs) 31 are shown integral to the back end 24 of the strap-retainer 20 while the female fastening segments (through-holes) 30 are integral to the fastening zone 15. The relative positioning of the fastening segments 30, 31 may be reversed in different embodiments of the device, with either of the fastening segments 30, 31 being placed on mutually opposite sides 26, 27 of the strap-retainer 20. Further, in all embodiments, the locations of the male and female segments 30, 31 may be reversed, in different embodiments of the handled plectrum assembly 21 relative to the front end 25 and the back end 24 of the strap-retainer 20.

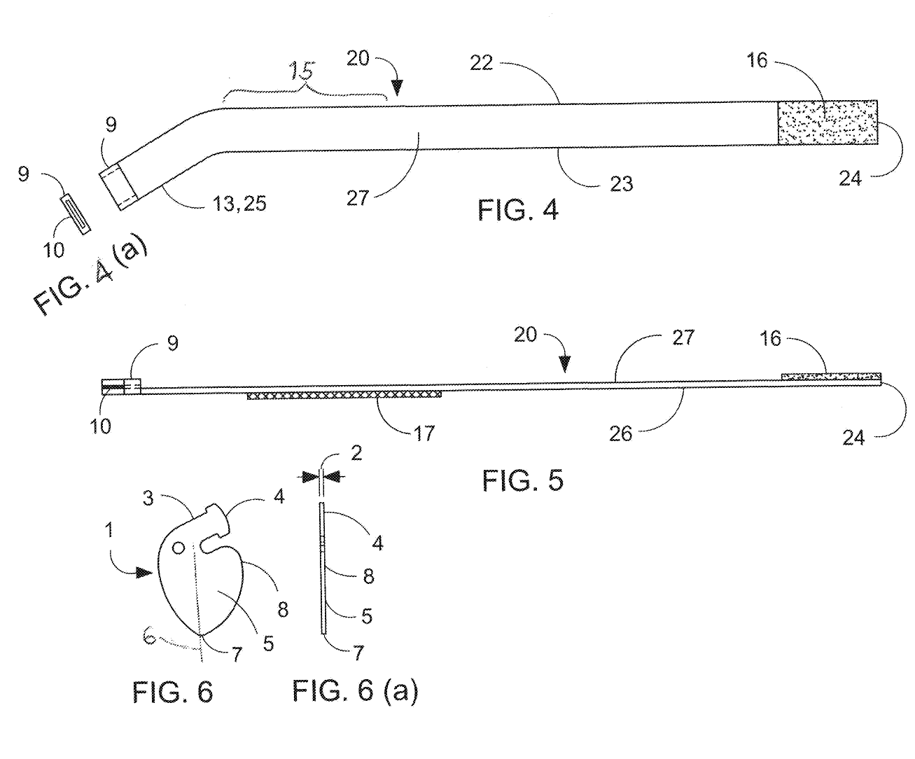

The handled plectrum assembly 21 functions by the player/musician looping the strap-retainer 20 into a sufficiently large (or small) circle to securely encompass one to three fingers of the user's playing hand. Once the loop is formed, the male fastener is placed in the vicinity of the fastening zone 15, which, in the preferred embodiment, contains the female fastener segment. For illustrative purposes, an embodiment depicting a hook-and-felt type fastener is used in FIG. 4 and FIG. 5. The player/user may press the hook component 16 being the male fastener, onto the felt component 17, or the female fastener (hidden from view in FIG. 4) within the range of distance covered by the fastening zone 15.

Similarly, as shown in FIG. 1, the player may press a plurality of the pegs 31 onto a portion of the through-holes 30 that are constructed within the fastening zone 15, to render a functional handled plectrum assembly 21 ready for playing. Prior to this fastening operation, the user will have selected an appropriate thickness plectrum 1 to insert into the receptor 9 of the strap-retainer 20. In other embodiments, a plurality of snap fasteners or press studs, (a pair of interlocking male and female discs) may be used in the fastening zone 15 of the strap-retainer 20. A male snap fastener, being a circular lip under one disc, fits into a groove on the top of the other, a female fastener, thereby holding both of them fast after a minimal amount of force is applied.

In referring to FIGS. 4 and 5 there is shown a hook-and-felt fastening mechanism wherein the male fastening segment (or felt) 16 is shown integral to the back end 24 of the strap-retainer 20 while the female fastening segment (hook component) 17 is integral to the fastening zone 15. The relative positioning of the fastening segments 16, 17 may be reversed in different embodiments of the device, with either of the hook and felt segments 16, 17 being placed on mutually opposite sides 26, 27 of the strap-retainer 20. Further, the locations of the hook and felt segments 16, 17 may be reversed in different embodiments of the handled plectrum assembly 21 relative to the front end 25 and the back end 24 of the strap-retainer 20.

In viewing FIG. 6 and FIG. 6(a), there is shown a detailed presentment of the plectrum 1. A plectrum snubber 4, which is an extension of the handle 3 of the plectrum 1, is designed with perimentral dimensions slightly larger than the interior dimensions of a channel 10 within the receptor 9. The receptor 9 is of an elastomeric material which expands to accept the handle 3 of the plectrum 1 and the snubber 4. Once inserted, the snubber 4 securely holds the plectrum 1 in an orientation within the receptor 9 which affords the player a secure gripping texture when thumb and index finger pressure is placed on both sides of the receptor 9, simultaneously maintaining constant contact with the upper portion of the plectrum 1. The brace 8 of the plectrum 1 also gives the player comfortable leverage for securely aiming and placing the apex 7 and body 5 of the plectrum 1 against the selected strings of the musical instrument, particularly during rapid music passages.

For general consumer marketing, most plectrums or picks are fabricated of a relatively inexpensive, thin plastic or other material which may be constructed in a range of thicknesses from 0.30 mm to 3.0 mm or more. Reference is made to FIG. 6(a), depicting the plectrum 1 dimension 2. Plectrums are designed to bend a certain amount and therefore, according to the individual taste of a musician, different thicknesses of plectrums may be selected. The plectrum 1 of the disclosed device is also constructed in a variety of thicknesses, which gives a musician the option of selecting different weights and stiffness of plectrums. As necessary, and when time permits, the musician need only pull the current plectrum 1 in use from the grip of the receptor 9, insert a replacement plectrum 1 into the receptor 9, and resume playing.

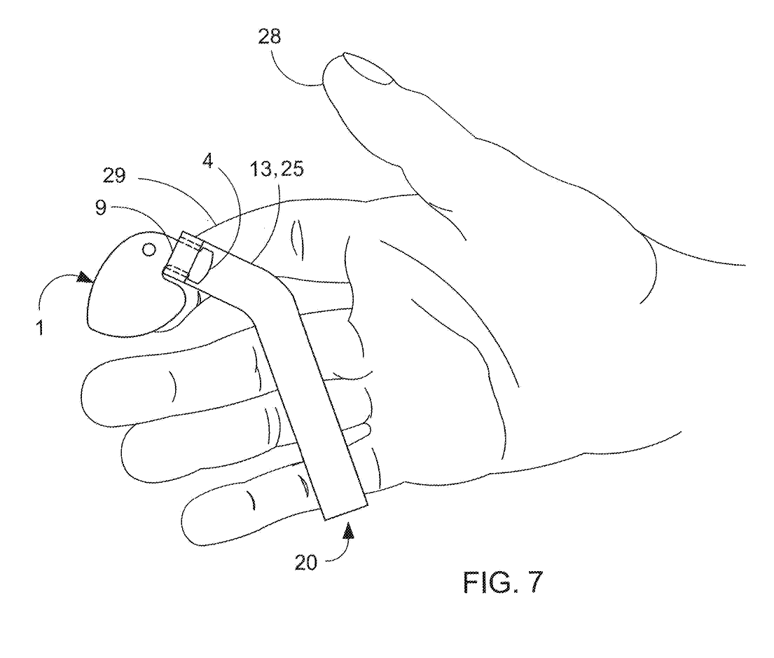

In referring to FIG. 7, there is illustrated the right hand of a musician or user of the device, shown after having fully encompassed his/her outer three fingers within the loop formed by fastening of the strap-retainer 20. To prepare for playing a stringed instrument with the device, the musician need only place his/her thumb-tip 28 against the juncture of the receptor 9 and the top portion of the plectrum 1 while simultaneously pressing against the tip of the index finger 29. In this manner, the user may be assured of adequately gripping texture and orientation of the plectrum 1 against the strings of a guitar or other stringed instrument. The lower three fingers may very lightly grasp the contacted portion of the strap-retainer 20, which naturally enhances an ergonometric positioning of the user's wrist, forearm and hand, particularly relative to guitar strings.

For the finger-plucking style of guitar playing, the user may release the grip of the thumb-tip 28 and index finger 29 on the plectrum 1, thereby freeing all five fingers of the hand for plucking or strumming the instrument strings. Depending on a user's preference, he/she may fasten the strap-retainer 20 about only one finger, or any combination of the lower three fingers shown in FIG. 7. When not in use, the fastened strap-retainer 20 may be stored on the head or lug nuts of the guitar.

The strap-retainer 20 may comprise any one of a number of different types of materials including, but not limited to, plastic, rubber, cloth, canvas, leather, or any of several elastomeric substances or alternatively, rigid materials. The fastening zone 15 and areas immediately adjacent to the fastening zone 15 may be of a rigid material while the remaining portions of the strap-retainer 20 may be constructed from an elastomeric material. Further, the fastening zone 15 may be configured to accept an orthogonal, or other angular fastening of the back end 24 of the strap-retainer 20 onto the fastening zone 15.

It must be realized that the embodiments presented in this inventive concept are not dependent solely upon any particular type of materials or fastening mechanism as the means of efficient or effective fastening of the retainer-strap 20. Fastening means such as zippers, pins, suction devices, track-and-groove fasteners, miniature snaps, magnets, or other mechanisms may function as well, if not better. A variety of fastening means as well as plectrum grasping means are readily capable of providing the functionality encompassed by this inventive concept. It is a fact that those skilled in the art may devise similar embodiments that are nevertheless, envisioned within the scope and limitations disclosed in this document.

What is claimed is:

1. A device haying two replaceable components, being a plectrum and a strap-retainer, whereby the two components, when formed into an assembly, provide a means for accurate and ergonomic plectrum-style playing of a stringed musical instrument, said device comprising
(a) a plectrum of flat, planar structure in the approximate shape of an isosceles triangle having two rounded base angles, an elliptically-shaped planar picking point at its apex, and a base having an orthogonally protruding handle, said handle further culminating in a snubber;
(b) a flexible, primarily longitudinal strap-retainer having an outer surface, an inner surface, a front end, a back end, a top edge, a lower edge, and a fastening zone, wherein said front end transitions into a segment forming a flap, said flap further constructed with a receptor, said receptor having a channel of interior dimensions corresponding to the dimensions of the handle of said plectrum; and
(c) a means for adjustably fastening the back end of said strap-retainer to any one of a plurality of locations within the fastening zone of said strap-retainer, such that a loop formed by the fastened strap-retainer may enclose one, two, or three fingers of a user.

2. A device having two replaceable components, being a plectrum and a strap-retainer, whereby the two components, when formed into an assembly, provide, a combination of plectrum grasping enhancement and an immediate and readily-accessible storage location for said plectrum when not in use, said device comprising
(a) a plectrum of flat, planar structure in the approximate shape of an isosceles triangle having two rounded base angles, an elliptically-shaped planar picking point at its apex, and a base having an orthogonally protruding handle, said handle further culminating in a snubber;
(b) a flexible, primarily longitudinal strap-retainer having an outer surface, an inner surface, a front end, a back end, a top edge, a lower edge, and a fastening zone, wherein said front end transitions into a segment forming a flap, said flap further constructed with a receptor, said receptor having a channel of interior dimensions corresponding to the dimensions of the handle of said plectrum; and
(c) a means for adjustably fastening the back end of said strap-retainer to any one of a plurality of locations within the fastening zone of said strap-retainer, such that a loop formed by the fastened strap-retainer may enclose one, two, or three fingers of a user.

3. A device having two replaceable components, being a plectrum and a strap-retainer, whereby the two components, when formed into an assembly, facilitate ease of switching alternatively from plectrum-style playing of a musical piece on a guitar to the technique of finger-plucking style of play, with said plectrum remaining immediately accessible, said device comprising
(a) a plectrum of flat, planar structure in the approximate shape of an isosceles triangle having two rounded base angles, an elliptically-shaped planar picking point at its apex, and a base haying an orthogonally protruding handle, said handle further culminating in a snubber;
(b) a flexible, primarily longitudinal strap-retainer having an outer surface, an inner surface, a front end, a back end, a top edge, a lower edge, and a fastening zone, wherein said front end transitions into a segment forming a flap, said flap further constructed with a receptor, said receptor having a channel of interior dimensions corresponding to the dimensions of the handle of said plectrum; and
(c) a means for adjustably fastening the back end of said strap-retainer to any one of a plurality of locations within the fastening zone of said strap-retainer, such that a loop formed by the fastened strap-retainer may enclose one, two, or three fingers of a user.

4. A device as in any one of claims 1, 2, or 3, wherein said strap-retainer comprises a structure selected from the group consisting of string, cord, strap, tube, rope, band, belt, wire, and chain.

5. A device as in any one of claims 1, 2, or 3, wherein said means for detachably fastening the back end of said strap-retainer to a plurality of locations within said fastening zone comprises a hook-and-felt fastening mechanism, having the hook component integral to the back end of said strap-retainer and the felt component integral to the fastening zone of said strap-retainer.

6. A device as in any one of claims 1, 2, or 3, wherein said fastening zone is integral the inner surface of said strap-retainer and comprises the female segment of a fastening mechanism and the outer surface of said strap-retainer, proximate the back end, comprises the male segment of the fastening mechanism.

7. A device as in any one of claims 1, 2, or 3, wherein said means for detachably fastening the back end of said strap-retainer to a plurality of locations within said fastening zone is selected from the group consisting of press-fit elastomeric grooves, male and female snaps, magnetized materials, peg and hole fasteners, flanged-ridged fittings, and tongue-and-groove fittings.
